(19) United States
(12) Patent Application Publication
(10) Pub. No.: US 2020/0348192 A1
(43) Pub. Date: Nov. 5, 2020

(54) PRESSURE SWITCH DEVICE AND PRINTED CIRCUIT BOARD HAVING THE SAME

(71) Applicant: Chemtronics Co., Ltd., Sejong (KR)

(72) Inventors: Yong-Un PARK, Yongin-si (KR); Jae Min JUNG, Osan-si (KR)

(73) Assignee: Chemtronics Co., Ltd., Sejong (KR)

(21) Appl. No.: 16/762,617

(22) PCT Filed: Nov. 6, 2018
(86) PCT No.: PCT/KR2018/013393

§ 371 Date: May 8, 2020

(30) Foreign Application Priority Data
Nov. 10, 2017 (KR) 10-2017-0149735

(51) Int. Cl. G01L 1/16; G05G 1/02

(52) U.S. Cl. CPC G01L 1/16; G05G 1/02

(57) ABSTRACT

A pressure switch device is disclosed. The pressure switch device includes a substrate formed of a flexible material, provided with a hole perforated therethrough, and including a rib extending from an inner circumference of the hole and being bendable toward a sensor disposed adjacent thereto by an external force, a contact portion disposed on the rib and forming a contact point with the sensor by the external force, a holder unit fixed to the substrate to be disposed on a peripheral area of the hole and an upper end of the rib, and a piezoelectric sensor disposed between the substrate and the holder unit, supported by the holder unit, and having a disc shape. A printed circuit board includes the pressure switch device.

### TECHNICAL FIELD

The present disclosure relates to a pressure switch device. More particularly, the present disclosure relates to a pressure switch device that transmits a pressure to allow the pressure to be concentrated at a target position and disperses the pressure to achieve an accurate switching operation when the pressure is provided to outside the target position and a printed circuit board having the pressure switch device.

### BACKGROUND ART

Recently, a touch input device using a device that senses a touch, such as a touch sensing device, is being developed as an input unit for controlling the operation of many electrical/electronic devices.

In principle, the touch sensing device is a device that recognizes the touch itself, and the touch input device is a device used as an input unit that performs a touch sensing operation and outputs the sensed touch as a signal, but actually they are used without much distinction.

The touch sensing device is classified into a resistive type touch sensing device, a pressure type touch sensing device, an ultrasonic type touch sensing device, and a capacitive type touch sensing device, and recently the capacitive type touch sensing device is widely used. The capacitive type touch sensing device senses the touch based on a variation in capacitance, which is caused by a user's touch.

When the pressure provided from the outside is sensed with the above-described various sensors, being able to easily transmitting the pressure from the outside to the sensor is a way to increase the accuracy of the sensing operation.

In a conventional art, a structure for transmitting the pressure to a piezoelectric ceramic is complicated, and when a structure for transmitting the pressure is mounted on a corresponding product, there is a problem in that the transmission of the pressure is not easy due to variations according to an attachment method.

Conventionally, when a pressure switch is applied to a metal body, there is a problem in that a peripheral key is recognized by stiffness of the metal body.

A related prior art is disclosed in Korea Patent Publication No. 10-2015-0102309 (published date: Sep. 7, 2015), and the prior art discloses a pressure sensor for a touch panel.

### PRESENT DISCLOSURE

### Technical Problem

The present disclosure provides a pressure switch device that transmits a pressure to allow the pressure to be concentrated at a target position and disperses the pressure when the pressure is provided to outside the target position to achieve an accurate switching operation and a printed circuit board having the pressure switch device.

### Technical Solution

Embodiments of the inventive concept provide a pressure switch device including a substrate formed of a flexible material, provided with a hole perforated therethrough, and including a rib that extends from an inner circumference of the hole and is bendable toward a sensor disposed adjacent thereto by an external force, a contact portion disposed on the rib and forming a contact point with the sensor, a holder unit fixed to the substrate to be disposed on a peripheral area of the hole and an upper end of the rib, and a piezoelectric sensor disposed between the substrate and the holder unit and supported by the holder unit.

The hole has a circular shape or a polygonal shape.

The rib includes an extension member extending from the inner circumference of the hole and a disc, a polygonal disc, or a polygonal member disposed at an end of the extension member.

The contact portion is disposed on the disc or the polygonal member.

The holder unit includes a first holder body having a plate shape and disposed along a rim of the hole in the peripheral area of the hole on an upper surface of the substrate, a second holder body connected to the first holder body and having a shape corresponding to a shape of the extension member and the disc member, and a fixing portion disposed at opposite ends of the first holder body and attached to a pair of adhesive portions disposed in the substrate.

The fixing portion includes an adhesive member attached to each of the adhesive portions and a pair of elastic members bent from an end of the adhesive member, and an end of the elastic members is elastically in contact with an upper surface of the piezoelectric sensor having a disc shape.

A support end is disposed at the inner circumference of the hole to support a lower surface of the piezoelectric sensor, and the support end is disposed at a position corresponding to a position of the elastic members.

Each of the elastic members has a width greater than a width of each of the support ends.

The first holder body is provided with a recess portion that is defined therein, located in a vicinity of each of the elastic members, and recessed downward at a certain depth.

### Advantageous Effects

According to the above, the pressure switch device may transmit the pressure to allow the pressure to be concentrated at the target position and may disperse the pressure to achieve the accurate switching operation when the pressure is provided to outside the target position.

### DESCRIPTION OF DRAWINGS

The above and other advantages of the present disclosure will become readily apparent by reference to the following detailed description when considered in conjunction with the accompanying drawings wherein:

FIG. 1 is a perspective view showing a first example of a pressure switch device according to an exemplary embodiment of the present disclosure;

FIG. 2 is a perspective view showing a second example of a pressure switch device according to an exemplary embodiment of the present disclosure;

FIG. 3 is a perspective view showing a fixing portion of a holder unit shown in FIG. 2; and

FIG. 4 is a perspective view showing a third example of a pressure switch device according to an exemplary embodiment of the present disclosure.

### MODE FOR INVENTION

Hereinafter, a pressure switch device and a printed circuit board having the pressure switch device according to the present disclosure will be described in detail with reference to accompanying drawings.

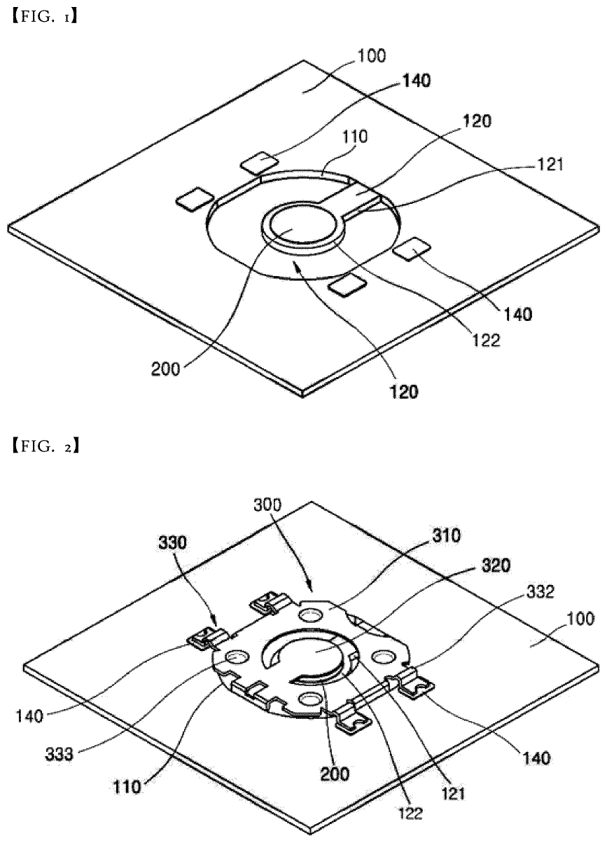

FIG. 1 is a perspective view showing a first example of a pressure switch device according to an exemplary embodiment of the present disclosure.

Referring to FIG. 1, the pressure switch device according to the present disclosure is installed on a printed circuit board and includes a substrate 100 on which a sensor (not shown) is installed.

The substrate 100 has a thickness of about 0.1t to about 1t and is formed of a flexible material.

The substrate 100 is provided with one or more holes 110 perforated therethrough.

In the present exemplary embodiment, it is preferred that the hole 110 is perforated to have a circular shape or a polygonal shape. The aim of the perforation of hole 110 in the circular or polygonal shape is to induce a distribution of the pressure that is transmitted to an outside of the hole 110 when the pressure is applied to a sensor described below.

A rib 120 is formed on an inner circumference of the hole 110.

The rib 120 has a length and includes an extension member 121 extending from the inner circumference of the hole 110 to a center of the hole 110 and a disc member 122.

The extension member 121 extends from the inner circumference of the hole 110 to be provided integrally with the substrate 100 and has a thickness that is substantially the same as a thickness of the substrate 100, however, the thickness of the extension member 121 may be smaller than or greater than the thickness of the substrate 100.

The disc member 122 is formed integrally with an end of the extension member 121 and has a thickness that is equal to, smaller than, or greater than the thickness of the substrate 100.

In the present exemplary embodiment, the disc member 122 is disposed at the center of the hole 110.

The substrate 100 includes a pair of adhesive portions 140 formed thereon.

The pair of adhesive portions 140 are formed in a vicinity of a rim of the hole no and are preferably formed at positions outside the circumference of the hole no.

In addition, a contact portion 200 is disposed on an upper surface of the disc member 122 according to the present disclosure.

One sensor among a capacitive sensor, an inductive sensor, and a piezoelectric sensor may be employed as a sensor contacted by the contact portion 200.

Referring to the above-mentioned structure, a conductive layer (not shown) may be disposed on an upper surface of the substrate 100.

The conductive layer may be disposed on the contact portion 200 and the upper surface of the substrate 100.

Accordingly, the rib 120 according to the present disclosure has a structural feature that moves up and down by an external force.

Therefore, the rib 120 may move up and down relatively smoothly compared with the substrate 100 through which the hole 110 is formed.

Thus, when the inductive sensor is employed in the present disclosure, there is an advantage that a variation in frequency between electrodes according to a distance is easily sensed.

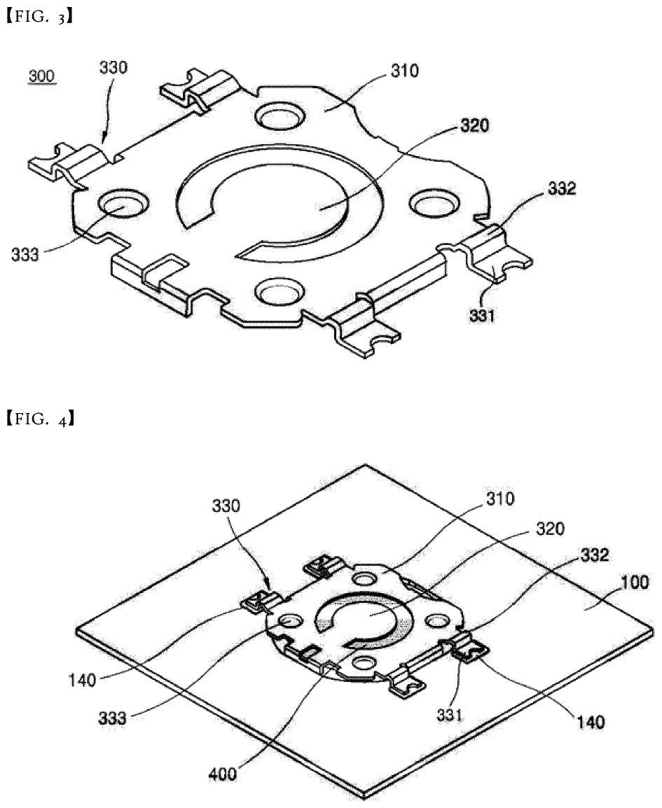

FIG. 2 is a perspective view showing a second example of a pressure switch device according to an exemplary embodiment of the present disclosure, and FIG. 3 is a perspective view showing a fixing portion of a holder unit shown in FIG. 2.

Referring to FIGS. 2 and 3, the pressure switch device of the present disclosure may include the substrate 100 and a holder unit 300.

The substrate 100 is provided with the hole 110 perforated therethrough and includes the rib 120.

The rib 120 includes the extension member 121 and the disc member 122.

In the present exemplary embodiment, since the rib 120 has substantially the same configurations as those of the rib 120 described with reference to FIG. 1, details thereof will be omitted.

In addition, the above-mentioned pair of adhesive portions 140 are formed at the rim of the hole 110.

The holder unit 300 according to the present disclosure is disposed on an upper surface of the substrate 100.

The holder unit 300 includes a first holder body 310, a second holder body 320, and a pair of fixing portions 330.

In the present exemplary embodiment, the holder unit 300 is formed of a metal having an elasticity in a plate shape

The first holder body 310 is formed in a semi-ring shape, e.g., C, or a rectangular frame shape, e.g., □, as a whole.

The first holder body 310 is disposed above the rim of the hole 110.

The first holder body 310 is preferably required to have a circumferential length that is at least half of a circumferential length of the hole 110.

The fixing portions 330 are formed at opposite ends of the first holder body 310.

The fixing portions 330 are preferably located on the adhesive portions 140 provided on the substrate 100 described above.

In the present exemplary embodiment, each fixing portion 330 includes an adhesive member 331 attached to each adhesive portion 140 and an elastic member 332 bent from an end of the adhesive member 331. An end of the elastic member 332 is elastically in contact with an upper surface of a disc-shaped generation system 400 described later.

The adhesive portions 140 may be a double-sided tape.

Accordingly, the fixing portions 330 may be attached and fixed to the adhesive portions 140.

Hereinafter, the elastic member 332 will be described.

The elastic member 332 is bent in a rectangular U shape, e.g., [symbol] . One end of the elastic member 332 is connected to an end of the adhesive member 331, and the other end of the elastic member 332 is located after being bent in the above shape inside the hole no.

Recess portions 333 are formed at corners of the first holder body 310 according to the present disclosure to have a certain depth downward. The recess portions 333 are located in the vicinity of the elastic members 332, respectively.

Meanwhile, the second holder body 320 according to the present disclosure extends from an inner center of the first holder body 310 along a center of the hole 110.

Preferably, the second holder body 320 has substantially the same shape as that of the rib 120 according to the present disclosure.

Accordingly, the second holder body 320 according to the present disclosure is disposed above the rib 120 according to the present disclosure and has a shape corresponding to the shape of the extension member 121 and the disc member 122.

In the above-described structure, the contact portion 200 is disposed on the upper surface of the disc member 122.

The second holder body 320 of the holder unit 300 described above is located at an upper end of the contact portion 200.

The rib 120 according to the present disclosure has a structural feature that moves up and down by the external force.

Accordingly, the rib 120 may move up and down relatively smoothly compared with the substrate Too through which the hole 110 is formed.

Thus, when the capacitive sensor is employed in the present disclosure, a distance between electrodes according to a moving distance may be easily measured, and when the piezoelectric sensor is employed, the pressure may be easily measured since the force transmitted from the outside is easily transmitted compared with a force transmitted in an area around the hole.

FIG. 4 is a perspective view showing a third example of a pressure switch device according to an exemplary embodiment of the present disclosure.

Referring to FIG. 4, the pressure switch device includes the substrate 100, the holder unit 300, and the generation system 400.

As described above, the substrate 100 is provided with the hole 110 perforated therethrough and includes the rib 120.

The rib 120 includes the extension member 121 and the disc member 122.

In the present exemplary embodiment, the rib 120 has substantially the same configurations as those of the rib 120 described with reference to FIG. 1, and thus, details thereof will be omitted.

In addition, the adhesive portions 140 described above are formed at the rim of the hole 120.

The holder unit 300 according to the present disclosure is disposed on the upper surface of the substrate 100.

In the present exemplary embodiment, the holder unit 300 has substantially the same configurations as those of the holder unit 300 described with reference to FIG. 2, and thus, details thereof will be omitted.

A support end 130 is formed on the inner circumference of the hole 110 according to the present disclosure to support a lower surface of the generation system 400.

The support end 130 is formed at a position corresponding to the position of the elastic member 332.

In the present exemplary embodiment, each elastic member 332 has a width greater than a width of each support end 130.

A cut-away member 332a that is cut and bent to surround an outer circumference of the generation system 400 is formed in each elastic member 332.

In addition, the disc-shaped generation system 400 is disposed between the substrate Too and the holder unit 300 and supported by the holder unit 300.

Preferably, the pressure sensor unit 400 is a piezo disc.

Accordingly, as shown in FIG. 4, a circumference of the pressure sensor unit 400 is disposed in the rim of the hole 110 and fixed by the first holder body 310.

In addition, the contact portion 200 is covered by the second holder body 320 of the holder unit 300 while being disposed on the disc member 122 of the rib 120.

According to the configurations, when the pressure caused by the external force is applied to the second holder body 320 in the present disclosure, the pressure is easily transmitted to the sensor through the contact portion 200 by the rib 120 that easily moves up and down.

Meanwhile, the pressure transmitted to the rim of the hole 110 is reduced after being absorbed by the rib 120 that moves up and down and is dispersed through the disc-shaped generation system 400.

Accordingly, when the piezoelectric sensor is employed in the present disclosure, the pressure provided from the outside is concentrated so that the pressure is easily transmitted to the sensor, and thus, the pressure may be easily measured.

According to the above configuration and operation, the pressure switch device according to the present exemplary embodiment transmits the pressure so that the pressure is concentrated at a target position and disperses the pressure to achieve an accurate switching operation when the pressure is provided to outside the target position.

As described above, specific embodiments of the pressure switch device of the present disclosure and the printed circuit board having the pressure switch device are described, however, it is obvious that various modifications of the embodiments are possible as long as they do not depart from the scope of the present disclosure.

Therefore, the disclosed subject matter should not be limited to any single embodiment described herein, and the scope of the present inventive concept shall be determined by not only the following claims but also their equivalents.

In other words, it is to be understood that the disclosed embodiments are illustrative and not restrictive in all respects and that the scope of the present inventive concept is indicated by the following claims rather than the detailed descriptions, and it is to be construed that the meaning and scope of the claims and all variations or modified forms derived from the equivalent concept thereof should be interpreted as being included in the scope of the present disclosure.

1. A pressure switch device comprising:
a substrate formed of a flexible material, provided with a hole perforated therethrough, and comprising a rib that extends from an inner circumference of the hole and is bendable toward a sensor disposed adjacent thereto by an external force;
a contact portion disposed on the rib and forming a contact point with the sensor;
a holder unit fixed to the substrate to be disposed on a peripheral area of the hole and an upper end of the rib; and
a piezoelectric sensor disposed between the substrate and the holder unit and supported by the holder unit.

2. The pressure switch device of claim 1, wherein the hole has a circular shape or a polygonal shape, the rib comprises:
an extension member extending from the inner circumference of the hole; and
a disc, a polygonal disc, or a polygonal member disposed at an end of the extension member, and the contact portion is disposed on the disc or the polygonal member.

3. The pressure switch device of claim 2, wherein the holder unit comprises:
a first holder body having a plate shape and disposed along a rim of the hole in the peripheral area of the hole on an upper surface of the substrate;
a second holder body connected to the first holder body and having a shape corresponding to a shape of the extension member and the disc member; and
a fixing portion disposed at opposite ends of the first holder body and attached to a pair of adhesive portions disposed in the substrate.

4. The pressure switch device of claim 3, wherein the fixing portion comprises:
an adhesive member attached to each of the adhesive portions; and
a pair of elastic members bent from an end of the adhesive member, and an end of the elastic members is elastically in contact with an upper surface of the piezoelectric sensor having a disc shape.

5. The pressure switch device of claim 4, wherein a support end is disposed at the inner circumference of the hole to support a lower surface of the piezoelectric sensor, and the support end is disposed at a position corresponding to a position of the elastic members.

6. The pressure switch device of claim 5, wherein each of the elastic members has a width greater than a width of each of the support ends.

7. The pressure switch device of claim 4, wherein the first holder body is provided with a recess portion that is defined therein, located in a vicinity of each of the elastic members, and recessed downward at a certain depth.

8. A printed circuit board comprising a pressure switch device as claimed in claim 1.
